(19) United States
(12) Patent Application Publication
(10) Pub. No.: US 2024/0225370 A1
(43) Pub. Date: Jul. 11, 2024

(54) Lifting and Carrying Apparatus for Structurally Weakened Containers

(71) Applicant: Leibish Kuten, Brooklyn, NY (US)

(72) Inventor: Leibish Kuten, Brooklyn, NY (US)

(21) Appl. No.: 18/407,002

(22) Filed: Jan. 8, 2024

Related U.S. Application Data
(60) Provisional application No. 63/478,756, filed on Jan. 6, 2023.

(51) Int. Cl. A47J 45/10

(52) U.S. Cl. CPC A47J 45/10

(57) ABSTRACT

A lifting and carrying apparatus for structurally weakened containers includes a handle, a left supporting arm, and a right supporting arm. The left supporting arm and the right supporting arm each includes a mounting section, a back support, a lateral support, and an auxiliary support. The left supporting arm and the right supporting arm are symmetrically positioned of each other about the handle and outwardly connected to the handle. A proximal end of the mounting section is terminally connected to a front end of the handle. The back support is terminally connected to a distal end of the mounting section and perpendicularly positioned to the mounting section. The lateral support is terminally connected to the back support, opposite of the mounting section, and perpendicularly positioned to the back support. The auxiliary support is terminally connected to the lateral support, opposite of the back support.

The current application claims a priority to the U.S. provisional patent application Ser. No. 63/478,756 filed on Jan. 6, 2023. The current application is filed on Jan. 8, 2024, while Jan. 6, 2024 was on a weekend.

### FIELD OF THE INVENTION

The present invention relates generally to a lifting and carrying handles that are designed for structurally weakened containers. More specifically, the present invention is a hot container lifter with heat resistant handle and generally horizontal rigid supporting members with curved terminations to secure the structurally weakened container within the rigid supporting members.

### BACKGROUND OF THE INVENTION

The need for hot container lifters comes substantially from safe food and handling requirements when moving and transporting containers with heated substances. The required contact to lift and transport such containers is made difficult for bare hand transport due to the elevated temperatures. Devices for handling hot substances have been in use for a long time. A common device is fabric potholders which requires the user to hold the container in the user's hands with only a piece of fabric between the container and the user's hand. The user is still able to feel the heat and can be burned if the container is sufficiently hot and the fabric is not sufficiently thick. The need for a more efficient heat resistance device is required to avoid this issue. The use of containers to store frozen substances, typically food, has increased with frozen foods becoming widely available and cost efficient. The containers have to be highly versatile to store frozen foods in freezing temperatures and then able to withstand high heat as the contents are prepared for consumption. As result, aluminum foil pans are generally utilized to store food items in freezing temperature as the same aluminum foil pan allows the users to heat up the stored food items. However, the aluminum foil pans are structurally weak and cannot support the weight of the contents by itself, often leading to spillage of food. To overcome the aforementioned problem, the aluminum foil pans need additional support by either manual contact or more substantial support to avoid dropping the container and its contents due to collapse of the container.

An objective of the present invention is to provide a container carrying device that is rigid and can support the lifting and carrying of containers that may be structurally weak. The present invention can provide rigid support for the edges and peripheral flanges common to many containers. The present invention has a rigid supporting frame with a handle for assisting in transporting the container and the contents. The present invention has curved terminations to secure the container in the device.

Another objective is to provide a container carrying device that is heat resistant and able to carry heated substances in containers even if containers are heat conductive such as aluminum foil pans without additional devices. The present invention is made from heat resistant materials to slow the conduction of heat from the container and contents through the carrying device to the hand of the user.

The present invention is to provide contour edges so that the supporting frame can be intimately engaged with the container that typically have angle lateral sides. The present invention has a handle made of heat-resistant material and is contoured for comfort.

### SUMMARY OF THE INVENTION

A lifting and carrying apparatus for structurally weakened containers is to provide a means for transporting heated containers and substances while keeping the user from being burned or dropping a structurally weakened container. The present invention is configured with a handle that is contoured for comfort and made from heat-resistant material. A supporting frame that is connected to the handle and outwardly projected from the handle. The supporting frame is shaped to engage with the structurally weakened containers so that the user can easily lift and carry structurally weakened containers such as aluminum foil pans.

### BRIEF DESCRIPTION OF THE DRAWINGS

FIG. 1 is a perspective view of the first embodiment of the present invention.

FIG. 2 is a left side view of the first embodiment of the present invention.

FIG. 3 is a right side view of the first embodiment of the present invention.

FIG. 4 is a top view of the first embodiment of the present invention.

FIG. 5 is a detailed view showing the connection between the mounting section and the handle of the present invention.

FIG. 6 is a top view of the first embodiment of the present invention, showing the third curved section.

FIG. 7 is a perspective view of the second embodiment of the present invention.

FIG. 8 is a top view of the second embodiment of the present invention, showing the front-left support and the front-right support.

FIG. 9 is a perspective view of the third embodiment of the present invention.

FIG. 10 is a top view of the third embodiment of the present invention, showing the fourth curved section.

FIG. 11 is a perspective view of the present invention, wherein the mounting section is configured as a raised section.

### DETAILED DESCRIPTION OF THE INVENTION

All illustrations of the drawings are for the purpose of describing selected versions of the present invention and are not intended to limit the scope of the present invention.

The present invention is a lifting and carrying apparatus for structurally weakened containers such as aluminum foil pans. The present invention is configured to engage with the lateral surfaces and the peripheral flanges of aluminum foil pans. Once the aluminum foil pan is secured within the present invention, the aluminum foil pan is ready to be lifted and transported.

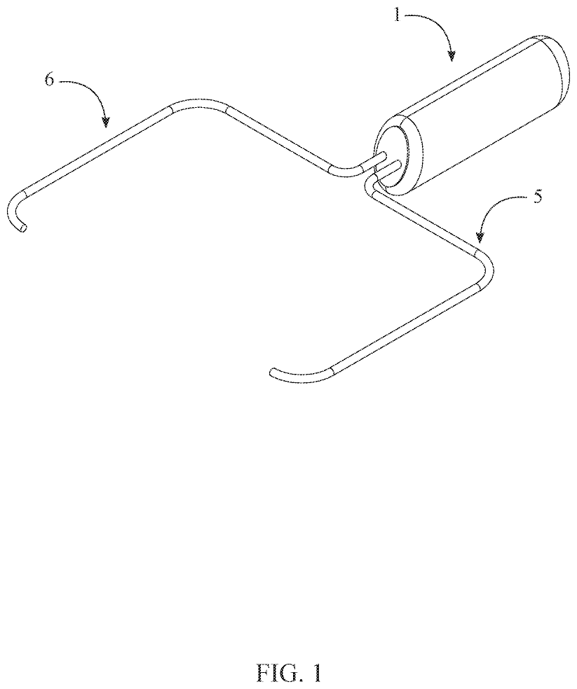

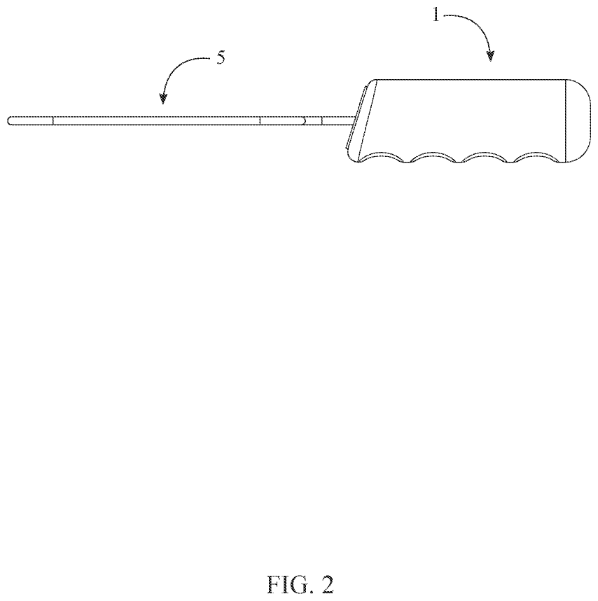

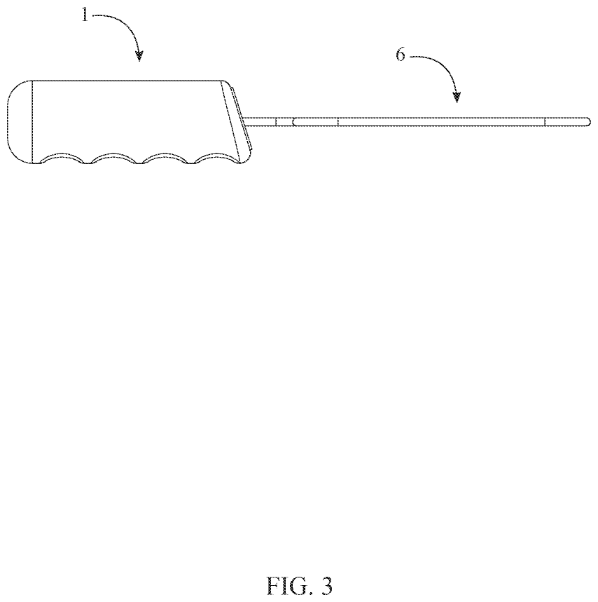

In reference to the general configuration, as shown in FIGS. 1-5, the present invention comprises a handle 1, a left supporting arm 5, and a right supporting arm 6. The handle 1 allows the user to grasp and maneuver the present invention. The left supporting arm 5 and the right supporting arm 6 are configured and positioned to receive the aluminum foil pan within. More specifically, the left supporting arm 5 and the right supporting arm 6 are symmetrically positioned of each other about the handle 1 thus allowing the aluminum foil pan to be balanced in relation to the handle 1. The left supporting arm 5 and the right supporting arm 6 are outwardly connected to the handle 1 so that the handle 1 is positioned outside of the aluminum foil pan when the present invention is utilized. Preferably, the present invention slides underneath the peripheral flanges of the aluminum foil pan so that the left supporting arm 5 and the right supporting arm 6 are able to engage with the lateral surfaces and the peripheral flanges of the aluminum foil pan. As a result, the present invention allows the user to easily lift and carry the aluminum foil pan.

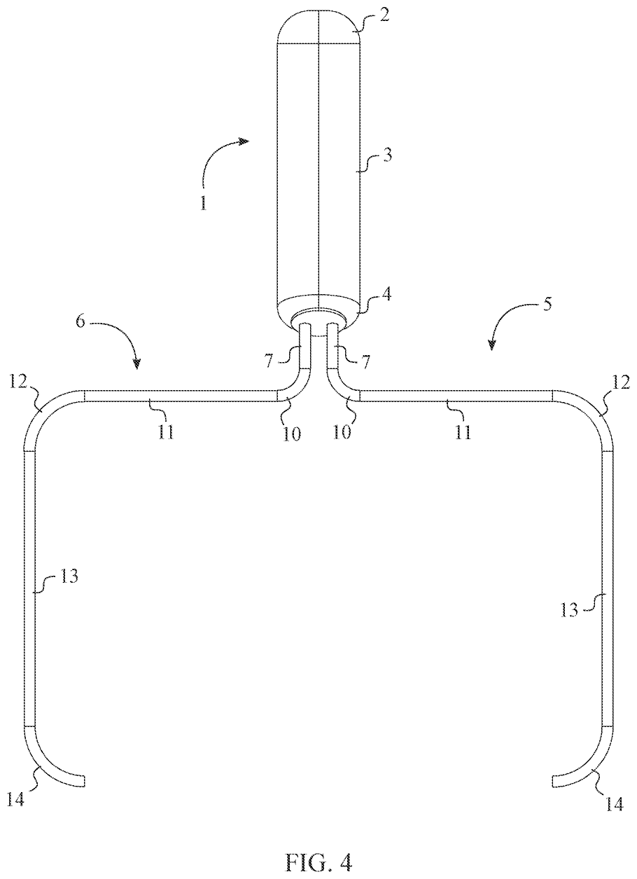

The handle 1 is preferably formed into a cylindrical shape so that the user can comfortably grip the present invention. In reference to FIG. 4, the handle 1 may comprise a front end 4, a rear end 2, and a gripping body 3. The gripping body 3 is positioned in between the front end 4 and the rear end 2 and contoured for the user's hand for comfort and easier manual gripping. The front end 4 is perimetrically connected to the gripping body 3. The front end 4 is generally configured into a flat surface area so that the left supporting arm 5 and the right supporting arm 6 can be outwardly extended. The rear end 2 is perimetrically connected to the gripping body 3. The rear end 2 is generally configured into a rounded end so that the handle 1 does not inadvertently tangle with user's clothing. The handle 1 is made of heat-resistant materials such as plastic, wood, ceramic, or combination of thereof so that the heat energy of the aluminum foil pan does not transfer into the handle 1 via the left supporting arm 5 and the right supporting arm 6. The handle 1 is preferably manufactured in two halves and then attached together with fasteners thus interlocking the left supporting arm 5 and the right supporting arm 6 within. As a result, the left supporting arm 5 and the right supporting arm 6 are able to securely connect and traverse through the front end 4 of the handle 1.

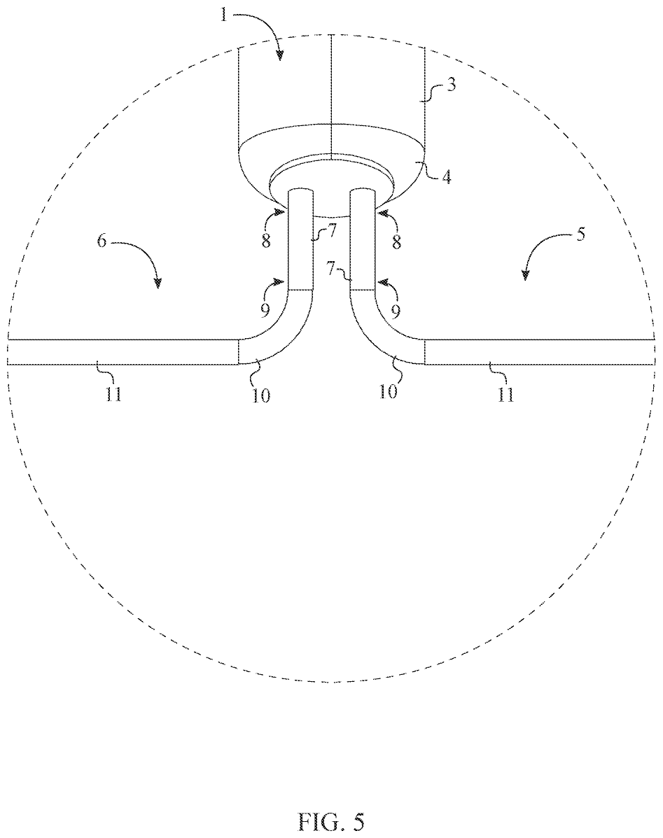

In reference to FIGS. 4 and 5, the left supporting arm 5 and the right supporting arm 6 may each comprise a mounting section 7, a back support 11, a lateral support 13, and an auxiliary support 14 so that the general configuration of the left supporting arm 5 and the right supporting arm 6 can be explained. More specifically, a proximal end 8 of the mounting section 7 is terminally connected to the front end 4 of the handle 1 in such a way that a distal end 9 of the mounting section 7 is externally positioned to the front end 4 of the handle 1. The back support 11 is terminally connected to the distal end 9 of the mounting section 7 and perpendicularly positioned to the mounting section 7. The back support 11 section is outwardly oriented from the handle 1 so that the back-lateral surface and the back-peripheral flange of the aluminum foil pan can be supported. In other words, the back support 11 section of the left supporting arm 5 and the back support 11 section of the right supporting arm 6 are linearly positioned along the back-lateral surface and the back-peripheral flange of the aluminum foil pan when the present invention is engaged with the aluminum foil pan. The lateral support 13 is terminally connected to the back support 11 and positioned opposite of the mounting section 7. The lateral support 13 is positioned perpendicular to the back support 11 and parallel to the mounting section 7 so that the left-lateral surface, the right-lateral surface, the left-peripheral flange, and the right-peripheral flange of the aluminum foil pan can be supported via the lateral section. In other words, the lateral support 13 section of the left supporting arm 5 is perpendicularly connected to the back support 11 of the left supporting arm 5 so that the left-lateral surface and the left-peripheral flange of the aluminum foil pan can be supported. Similarly, the lateral support 13 section of the right supporting arm 6 is perpendicularly connected to the back support 11 of the right supporting arm 6 so that the right-lateral surface and the right-peripheral flange of the aluminum foil pan can be supported. The auxiliary support 14 is terminally connected to the lateral support 13 and positioned opposite of the back support 11 so that the aluminum foil pan does not slide forward and dislodge through the lateral support 13. The auxiliary support 14 can be configured into different embodiments without deviating from the scope of the functionality.

In reference to FIGS. 4 and 5, the left supporting arm 5 and the right supporting arm 6 may each further comprise a first curved section 10. The first curved section 10 functions as a curved-interconnecting body as the back support 11 is terminally connected to the distal end 9 of the mounting section 7 by the first curved section 10.

Preferably, terminal ends of the first curved section 10 are oriented at a right angle, and the first curved section 10 is outwardly oriented from the mounting section 7 so that the back support 11 can be perpendicularly positioned to the mounting section 7. As a result, the back support 11 of the left supporting arm 5 is positioned oppositely to the back support 11 of the right supporting arm 6 as the back support 11 of the left supporting arm 5 is axially positioned to the back support 11 of the right supporting arm 6. The first curved section 10 delineate a smooth and dull transition body between the mounting section 7 and the back support 11 so that the aluminum foil pan does not damage or pierce during the lifting or carrying process of the aluminum foil pan.

In reference to FIG. 4, the left supporting arm 5 and the right supporting arm 6 each further comprise a second curved section 12. The second curved section 12 functions as a curved-interconnecting body as the lateral support 13 is terminally connected to the back support 11 by the second curved section 12. Preferably, terminal ends of the second curved section 12 are oriented at a right angle, and the second curved section 12 is outwardly oriented from the front end 4 of the handle 1 so that the lateral support 13 can be perpendicularly positioned to the back support 11. As a result, the lateral support 13 of the left supporting arm 5 is positioned oppositely to the lateral support 13 of the right supporting arm 6 as the lateral support 13 of the left supporting arm 5 is positioned parallel to the lateral support 13 of the right supporting arm 6. The second curved section 12 firmly supports the back-left corner surface, the back-right corner surface, the back-left corner peripheral flange, and the back-right corner peripheral flange of the aluminum foil pan. More specifically, the second curved section 12 of the left supporting arm 5 is configured to support the back-left corner surface and the back-left corner peripheral flange of the aluminum foil pan. Similarly, the second curved section 12 of the right supporting arm 6 is configured to support the back-right corner surface and the back-right corner peripheral flange of the aluminum foil pan.

In reference to a first embodiment of the present invention, the auxiliary support 14 may comprise a third curved section 15 as shown in FIGS. 1-6. The third curved section 15 functions as a stopper so that the aluminum foil pan does not slide out from the present invention. Preferably, a fixed end 16 of the third curved section 15 and a free end 17 of the third curved section 15 are oriented at a right angle so that the aluminum foil pan can be secured with respect to the front corners. More specifically, the fixed end 16 of the third curved section 15 is terminally connected to the lateral support 13 and positioned opposite of the back support 11. The third curved section 15 of the left supporting arm 5 is oriented toward the right supporting arm 6, and the third curved section 15 of the right supporting arm 6 is oriented toward the left supporting arm 5. As a result, the free end 17 of the third curved section 15 of the left supporting arm 5 is concentrically positioned to the free end 17 of the third curved section 15 of the right supporting arm 6. The third curved section 15 firmly supports the front-left corner surface, the front-right corner surface, the front-left corner peripheral flange, and the front-right corner peripheral flange of the aluminum foil pan. More specifically, the third curved section 15 of the left supporting arm 5 is configured to support the front-left corner surface and the front-left corner peripheral flange of the aluminum foil pan. Similarly, the third curved section 15 of the right supporting arm 6 is configured to support the front-right corner surface and the front-right corner peripheral flange of the aluminum foil pan.

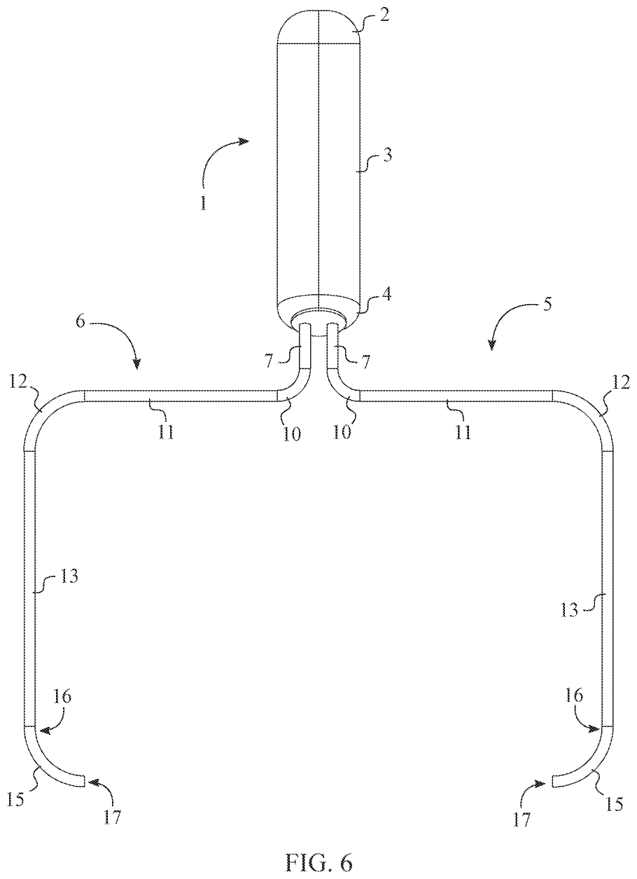

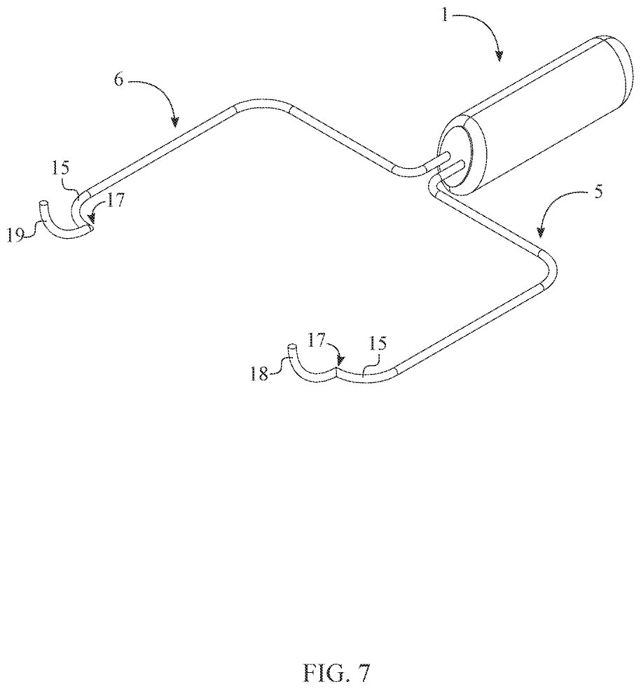

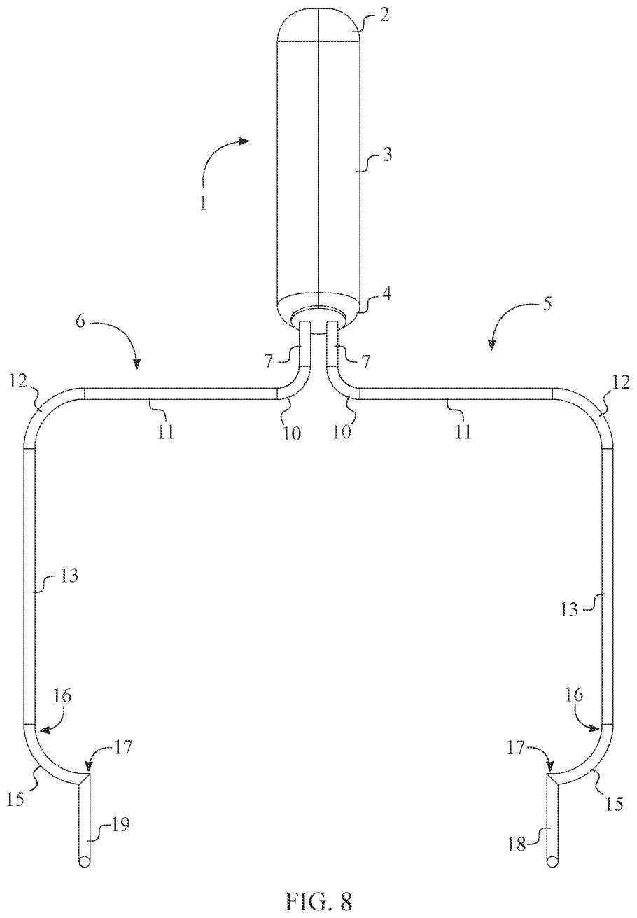

In reference to a second embodiment of the present invention, the present invention may further comprise a front-left support 18 and a front-right support 19, and the auxiliary support 14 may comprise the third curved section 15 as shown in FIG. 6. The third curved section 15 is configured and functions similar to the first embodiment of the present invention. More specifically, the fixed end 16 of the third curved section 15 is terminally connected to the lateral support 13 and positioned opposite of the back support 11. The third curved section 15 of the left supporting arm 5 is oriented toward the right supporting arm 6, and the third curved section 15 of the right supporting arm 6 is oriented toward the left supporting arm 5. As a result, the free end 17 of the third curved section 15 of the left supporting arm 5 is concentrically positioned to the free end 17 of the third curved section 15 of the right supporting arm 6. The third curved section 15 firmly supports the front-left corner surface, the front-right corner surface, the front-left corner peripheral flange, and the front-right corner peripheral flange of the aluminum foil pan. As shown in FIGS. 7 and 8, the front-left support 18 is terminally connected to the free end 17 of the third curved section 15 of the left supporting arm 5 and positioned offset from the third curved section 15 of the left supporting arm 5. The front-right support 19 is terminally connected to the free end 17 of the third curved section 15 of the right supporting arm 6 and positioned offset from the third curved section 15 of the right supporting arm 6. The front-right support 19 and the front-left support 18 are configured similar to the third curved section 15 as terminal ends of the front-right support 19 and the front-left support 18 are oriented at a right angle. More specifically, the front-left support 18 oriented upward as the end of the front-left support 18 is positioned above the left supporting arm 5. The front-right support 19 is oriented upward as the end of the front-right support 19 is positioned above the right supporting arm 6. As a result, the third curved section 15 of the left supporting arm 5, the third curved section 15 of the right supporting arm 6, the front-left support 18, and the front-right support 19 are able to function as a stopper so that the aluminum foil pan does not slide out from the present invention. In other words, the third curved section 15 of the left supporting arm 5 is configured to support the front-left corner surface and the front-left corner peripheral flange of the aluminum foil pan. Then, the front-left support 18 is able to function as an additional stopper and extends above the front-lateral surface and the front-peripheral flange of the aluminum foil pan. Similarly, the third curved section 15 of the right supporting arm 6 is configured to support the front-right corner surface and the front-right corner peripheral flange of the aluminum foil pan. Then, the front-right support 19 is able to function as an additional stopper and extends above the front-lateral surface and the front-peripheral flange of the aluminum foil pan.

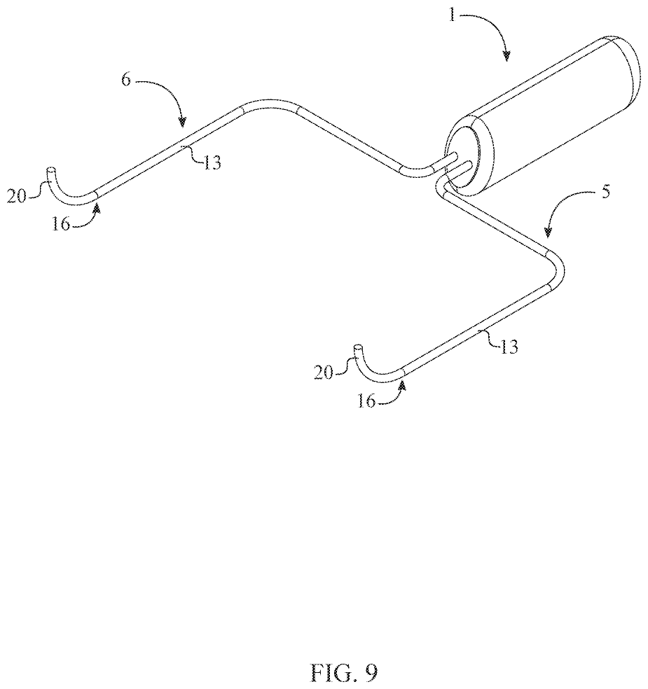

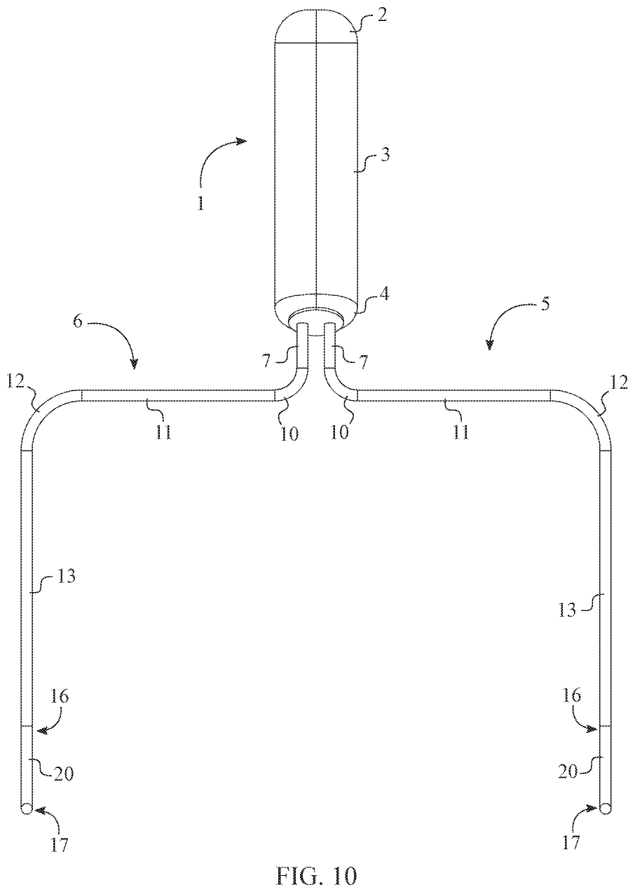

In reference to a third embodiment of the present invention, the auxiliary support 14 may comprise a fourth curved section 20 as shown in FIGS. 9 and 10. The fourth curved section 20 functions as a stopper so that the aluminum foil pan does not slide out from the present invention. Preferably, a fixed end 16 of the fourth curved section 20 and a free end 17 of the fourth curved section 20 are oriented at a right angle so that the aluminum foil pan can be secured with respect to the front corners. More specifically, the fixed end 16 of the fourth curved section 20 is terminally connected to the lateral support 13 and positioned opposite of the back support 11. The fourth curved section 20 of the left supporting arm 5 is oriented away from the lateral support 13 of the left supporting arm 5, and the fourth curved section 20 of the right supporting arm 6 is oriented away from the lateral support 13 of the right supporting arm 6. As a result, the free end 17 of the fourth curved section 20 of the left supporting arm 5 is axially aligned with the free end 17 of the fourth curved section 20 of the right supporting arm 6. The fourth curved section 20 firmly supports the front-left corner surface, the front-right corner surface, the front-left corner peripheral flange, and the front-right corner peripheral flange of the aluminum foil pan. More specifically, the fourth curved section 20 of the left supporting arm 5 is configured to support and extend above the front-left corner surface and the front-left corner peripheral flange of the aluminum foil pan. Similarly, the fourth curved section 20 of the right supporting arm 6 is configured to support and extend above the front-right corner surface and the front-right corner peripheral flange of.

In reference to FIGS. 1-10, the left supporting arm 5 and the right supporting arm 6 are preferably configured with a circular cross-section so that the left supporting arm 5 and the right supporting arm 6 are able to slide and fit adjacent to the peripheral flanges of aluminum foil pan. However, the left supporting arm 5 and the right supporting arm 6 can be configured with an oval cross-section, a triangular cross-section, or a rectangular cross-section without deviating from the scope of the functionality.

Even though the preferred embodiment is for a rectangular shaped aluminum foil pan, the present invention is not limited to this shape. It is understood that the components of the present invention can be configured to support a generally circular shaped aluminum foil pan without deviating from the scope of the functionality.

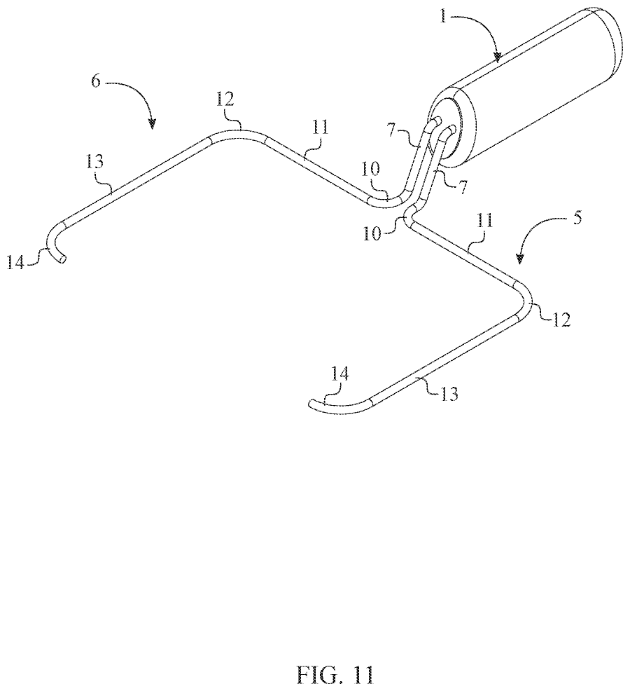

In some embodiment of the present invention, the mounting section 7 of the left supporting arm 5 and the mounting section 7 of the right supporting arm 6 are configured as raised sections as shown in FIG. 11. More specifically, the raised sections elevates the positioning of the handle 1 as the first curved section 10, the back support 11, the second curved section 12, the lateral support 13, and the auxiliary support 14 of the left supporting arm 5 and the right supporting arm 6 are positioned below the handle 1. In other words, the handle is positioned offset from the first curved section 10, the back support 11, the second curved section 12, the lateral support 13, and the auxiliary support 14 of the left supporting arm 5 and the right supporting arm 6. This configuration provides additional support and improved equilibrium for the lifting and carrying process of the aluminum foil pan as the user's hand is positioned above the aluminum foil pan.

Although the invention has been explained in relation to its preferred embodiment, it is to be understood that many other possible modifications and variations can be made without departing from the spirit and scope of the invention as hereinafter claimed.

What is claimed is:

1. A lifting and carrying apparatus for structurally weakened containers comprising:
a handle;
a left supporting arm;
a right supporting arm;
the left supporting arm and the right supporting arm each comprising a mounting section, a back support, a lateral support, and an auxiliary support;
the left supporting arm and the right supporting arm being symmetrically positioned of each other about the handle;
the left supporting arm and the right supporting arm being outwardly connected to the handle;
a proximal end of the mounting section being terminally connected to a front end of the handle;
the back support being terminally connected to a distal end of the mounting section;
the back support being perpendicularly positioned to the mounting section;
the back support section being outwardly oriented from the handle;
the lateral support being terminally connected to the back support, opposite of the mounting section;
the lateral support being perpendicularly positioned to the back support; and
the auxiliary support being terminally connected to the lateral support, opposite of the back support.

2. The lifting and carrying apparatus for structurally weakened containers as claimed in claim 1 comprising:
the handle further comprises a rear end and a gripping body;
the gripping body being positioned in between the front end and the rear end;
the front end being perimetrically connected to the gripping body; and
the rear end being perimetrically connected to the gripping body.

3. The lifting and carrying apparatus for structurally weakened containers as claimed in claim 1, wherein the left supporting arm is configured with a circular cross-section.

4. The lifting and carrying apparatus for structurally weakened containers as claimed in claim 1, wherein the right supporting arm is configured with a circular cross-section.

5. The lifting and carrying apparatus for structurally wea weakened ken containers as claimed in claim 1 comprising:
the left supporting arm and the right supporting arm each further comprising a first curved section;
the back support being terminally connected to the distal end of the mounting section by the first curved section;
the first curved section being outwardly oriented from the mounting section;
the back support of the left supporting arm being oppositely positioned to the back support of the right supporting arm; and
the back support of the left supporting arm being axially positioned to the back support of the right supporting arm.

6. The lifting and carrying apparatus for structurally weakened containers as claimed in claim 1 comprising:
the left supporting arm and the right supporting arm each further comprising a second curved section;
the lateral support being terminally connected to the back support by the second curved section;
the second curved section being outwardly oriented from the front end of the handle;
the lateral support of the left supporting arm being oppositely positioned to the lateral support of the right supporting arm; and
the lateral support of the left supporting arm being positioned parallel to the lateral support of the right supporting arm.

7. The lifting and carrying apparatus for structurally weakened containers as claimed in claim 1 comprising:
the auxiliary support comprising a third curved section;
a fixed end of the third curved section being terminally connected to the lateral support, opposite of the back support;
the third curved section of the left supporting arm being oriented toward the right supporting arm;
the third curved section of the right supporting arm being oriented toward the left supporting arm; and
a free end of the third curved section of the left supporting arm being concentrically positioned to a free end of the third curved section of the right supporting arm.

8. The lifting and carrying apparatus for structurally weakened containers as claimed in claim 7 comprising:
a front-left support;
a front-right support;
the front-left support being terminally connected to the free end of the third curved section of the left supporting arm;
the front-left support being positioned offset from the third curved section of the left supporting arm;
the front-right support being terminally connected to the free end of the third curved section of the right supporting arm; and
the front-right support being positioned offset from the third curved section of the right supporting arm.

9. The lifting and carrying apparatus for structurally weakened containers as claimed in claim 1 comprising:
the auxiliary support comprising a fourth curved section;
a fixed end of the fourth curved section being terminally connected to the lateral support, opposite of the back support;
the fourth curved section of the left supporting arm being oriented away from the lateral support of the left supporting arm; and
the fourth curved section of the right supporting arm being oriented away from the lateral support of the right supporting arm.

10. A lifting and carrying apparatus for structurally weakened containers comprising:
a handle;
a left supporting arm;
a right supporting arm;
the left supporting arm and the right supporting arm each comprising a mounting section, a back support, a lateral support, an auxiliary support, and a second curved section;
the left supporting arm and the right supporting arm being symmetrically positioned of each other about the handle;
the left supporting arm and the right supporting arm being outwardly connected to the handle;
a proximal end of the mounting section being terminally connected to a front end of the handle;
the back support being terminally connected to a distal end of the mounting section;
the back support being perpendicularly positioned to the mounting section;
the back support section being outwardly oriented from the handle;
the lateral support being terminally connected to the back support, opposite of the mounting section;
the lateral support being terminally connected to the back support by the second curved section;
the second curved section being outwardly oriented from the front end of the handle;
the lateral support of the left supporting arm being oppositely positioned to the lateral support of the right supporting arm;
the lateral support of the left supporting arm being positioned parallel to the lateral support of the right supporting arm;
the lateral support being perpendicularly positioned to the back support; and
the auxiliary support being terminally connected to the lateral support, opposite of the back support.

11. The lifting and carrying apparatus for structurally weakened containers as claimed in claim 10 comprising:
the handle further comprises a rear end and a gripping body;
the gripping body being positioned in between the front end and the rear end;
the front end being perimetrically connected to the gripping body; and
the rear end being perimetrically connected to the gripping body.

12. The lifting and carrying apparatus for structurally weakened containers as claimed in claim 10, wherein the left supporting arm is configured with a circular cross-section.

13. The lifting and carrying apparatus for structurally weakened containers as claimed in claim 10, wherein the right supporting arm is configured with a circular cross-section.

14. The lifting and carrying apparatus for structurally wea weakened ken containers as claimed in claim 10 comprising:
the left supporting arm and the right supporting arm each further comprising a first curved section;
the back support being terminally connected to the distal end of the mounting section by the first curved section;
the first curved section being outwardly oriented from the mounting section;
the back support of the left supporting arm being oppositely positioned to the back support of the right supporting arm; and
the back support of the left supporting arm being axially positioned to the back support of the right supporting arm.

15. The lifting and carrying apparatus for structurally weakened containers as claimed in claim 10 comprising:
the auxiliary support comprising a third curved section;
a fixed end of the third curved section being terminally connected to the lateral support, opposite of the back support;
the third curved section of the left supporting arm being oriented toward the right supporting arm;
the third curved section of the right supporting arm being oriented toward the left supporting arm; and
a free end of the third curved section of the left supporting arm being concentrically positioned to a free end of the third curved section of the right supporting arm.

16. The lifting and carrying apparatus for structurally weakened containers as claimed in claim 15 comprising:
a front-left support;
a front-right support;
the front-left support being terminally connected to the free end of the third curved section of the left supporting arm;
the front-left support being positioned offset from the third curved section of the left supporting arm;
the front-right support being terminally connected to the free end of the third curved section of the right supporting arm; and
the front-right support being positioned offset from the third curved section of the right supporting arm.

17. The lifting and carrying apparatus for structurally weakened containers as claimed in claim 10 comprising:
the auxiliary support comprising a fourth curved section;
a fixed end of the fourth curved section being terminally connected to the lateral support, opposite of the back support;
the fourth curved section of the left supporting arm being oriented away from the lateral support of the left supporting arm; and
the fourth curved section of the right supporting arm being oriented away from the lateral support of the right supporting arm.
